(19) United States
(12) Patent Application Publication
(10) Pub. No.: US 2007/0230069 A1
(43) Pub. Date: Oct. 4, 2007

(54) Magnetoresistive element, magnetic head, and magnetic reproducing apparatus

(75) Inventors: Hiromi Fuke, Yokohama-shi (JP); Susumu Hashimoto, Tokyo (JP); Masayuki Takagishi, Kunitachi-shi (JP); Hitoshi Iwasaki, Yokosuka-shi (JP)

Correspondence Address: NIXON & VANDERHYE, PC, 901 NORTH GLEBE ROAD, 11TH FLOOR, ARLINGTON, VA, 22203, US

(73) Assignees: Kabushiki Kaisha Toshiba, Tokyo (JP); TDK Corporation, Tokyo (JP)

(21) Appl. No.: 11/727,404

(22) Filed: Mar. 26, 2007

(30) Foreign Application Priority Data
Mar. 30, 2006 (JP) 2006-094850

(51) Int. Cl. G11B 5/33

(52) U.S. Cl. 360/324.11

(57) ABSTRACT

A magnetoresistive element has a magnetization pinned layer including a magnetic film a magnetization direction of which is substantially pinned in one direction, a magnetization free layer including a magnetic film a magnetization direction of which is varied depending on an external magnetic field, a composite spacer layer interposed between the magnetization pinned layer and the magnetization free layer, and including an insulating portion and a magnetic metal portion, and a pair of electrodes configured to supply a sense current in a direction perpendicular to planes of the magnetization pinned layer, the composite spacer layer and the magnetization free layer, in which the magnetic film included in the magnetization pinned layer and being in contact with the composite spacer layer has a bcc structure.

### CROSS-REFERENCE TO RELATED APPLICATIONS

This application is based upon and claims the benefit of priority from prior Japanese Patent Application No. 2006-094850, filed Mar. 30, 2006, the entire contents of which are incorporated herein by reference.

### BACKGROUND OF THE INVENTION

1. Field of the Invention

The present invention relates to a magnetoresistive element, a magnetic head, and a magnetic reproducing apparatus, and more specifically, to a magnetoresistive element having a structure in which a sense current is supplied in the direction perpendicular to the film plane of a magnetoresistive film, and a magnetic head and a magnetic reproducing apparatus which use the magnetoresistive element.

2. Description of the Related Art

Conventionally, in order to read out data recorded on a magnetic recording medium, a magnetic head (an MR head) including a magnetoresistive element making use of an anisotropic magnetoresistance effect has been used.

In recent years, efforts have been made to reduce the size of magnetic recording media while increasing their capacities. Accordingly, the relative speed between a read head and a magnetic recording medium during read operation has been decreasing. Under the circumstances, expectations to magnetoresistive heads which allow high outputs under the low relative speed have been increasing. It has been reported that a multilayered film with a sandwich structure including a ferromagnetic layer/a nonmagnetic layer/a ferromagnetic layer can successfully produce a giant magnetoresistance effect. Specifically, the nonmagnetic layer is referred to as a “spacer layer” or an “intermediate layer”, one of the ferromagnetic layer is referred to as a “pinned layer” or a “magnetization pinned layer”, and the other ferromagnetic layer is referred to as a “free layer” or a “magnetization free layer”. The magnetization of the pinned layer is pinned by applying an exchange biasing magnetic field with an antiferromagnetic layer. The magnetization of the free layer can be reversed in response to external magnetic fields (or signal magnetic fields). In this multilayer film, change in the relative angle between the magnetization directions of the two ferromagnetic layers on both sides of the nonmagnetic layer provides a giant magnetoresistance effect. The multilayered film of this type is called a “spin valve”.

Because the spin valve can saturate magnetization under a low magnetic field, it is suitable for a read head and has already been put into practical use. However, the magnetoresistance ratio of the spin valve is limited to about 20%, and thus an improved magnetoresistive element exhibiting a higher magnetoresistance ratio has been required.

The spin-valve type magnetoresistive element includes a CIP (current-in-plane) type in which a sense current is supplied in the direction parallel to the film plane and a CPP (current-perpendicular-to-plane) type in which a sense current is supplied in the direction perpendicular to the film plane. The aforementioned magnetoresistance ratio of about 20% corresponds to that for the CIP type element. It has been reported that the CPP type element exhibits a magnetoresistive ratio about ten times as high as that of the CIP type element. See J. Phys.: Condens. Matter vol. 11, pp. 5717-5722 (1999). It is not impossible for the CIP type element to achieve a magnetoresistance ratio of 100%.

In the spin-valve structure, however, the total thickness of the spin-dependent layers is very small and the number of interfaces is also small. Accordingly, if the CPP type element is supplied with a current in the direction perpendicular to the film plane, the element shows a low resistance and thus shows a low output absolute value. Specifically, when a spin valve of the same film structure as a CIP type element, which has a pinned layer and a free layer with a thickness of 5 nm, is supplied with a current in the direction perpendicular to the film plane, the output absolute value AΔR for 1 μm² becomes as small as about 0.5 mΩμm². Thus, it is important to increase the output in order to put the CPP type magnetoresistive element having the spin-valve film to practical use. To achieve this, it is critical to increase the resistance value of a part of the magnetoresistive element which contributes to spin-dependent conduction, and to increase the resistance change.

On the other hand, in recent years, a magnetoresistance effect of 300% has been observed in Ni nanocontacts (see Phys. Rev. Lett., 82, 2923 (1999)). In order to apply a nanocontact between ferromagnetic materials to a device, it is necessary to produce the nanocontact two-dimensionally in a plane, or to manufacture the nanocontact three-dimensionally in the perpendicular direction to the film plane (JP-A 2003-204095 (KOKAI)). An approach to produce the nanocontact in a plane includes a process such as lithography. However, the size of the nanocontact may be about several nanometers in a minimum case, which has limitations in deriving a physical phenomenon caused by the junction at an atomic level. On the other hand, JP-A 2003-204095 (KOKAI) discloses a method of manufacturing three-dimensional nanocontacts by physically forming holes in a film using methods such as an electron-beam (EB) irradiation process, a focused ion beam (FIB) process and an atomic force microscope (AFM) technique. In this document, nanocontacts are manufactured by making use of self-assembling chemical reaction such as diffusion, mixing, alloying and separation of materials during deposition. Therefore, a CPP type spin valve film having a stacked structure may be much affected by lattice matching between lattice matching such as crystal structures and lattice constants, crystal growth of a film, and a process for forming metal paths. The MR effect exhibited by the nanocontacts between the magnetic materials is made higher as the width of domain wall in the contact portion is made narrower. In order to narrow the width of domain wall, it is necessary to reduce a metal path size. However, a relationship between the MR characteristics and the crystal structures of a composite spacer and an underlying layer thereof for obtaining a higher MR effect has not been clarified. Thus, there is a room to improve the MR characteristics by clarifying the above relationship.

### BRIEF SUMMARY OF THE INVENTION

According to an aspect of the present invention, there is provided a magnetoresistive element comprising: a magnetization pinned layer including a magnetic film a magnetization direction of which is substantially pinned in one direction; a magnetization free layer including a magnetic film a magnetization direction of which is varied depending on an external magnetic field; a composite spacer layer interposed between the magnetization pinned layer and the magnetization free layer, and including an insulating portion and a magnetic metal portion; and a pair of electrodes configured to supply a sense current in a direction perpendicular to planes of the magnetization pinned layer, the composite spacer layer, and the magnetization free layer, the magnetic film included in the magnetization pinned layer and being in contact with the composite spacer layer having a bcc structure.

### BRIEF DESCRIPTION OF THE SEVERAL VIEWS OF THE DRAWING

FIG. 1 is a cross-sectional view of the magnetoresistive element according to Example 1;

FIG. 2 is a cross-sectional view of the magnetoresistive element according to Example 2;

FIG. 3 is a graph showing a relationship between an areal resistance RA and an MR ratio with respect to magnetoresistive elements in Examples 1 and 2, and Comparative Examples 1, 2, and 3;

FIG. 4 is a perspective view of a magnetic recording/reproducing apparatus according to an embodiment; and

FIG. 5 is a perspective view of a head gimbal assembly according to an embodiment.

### DETAILED DESCRIPTION OF THE INVENTION

A magnetoresistive element according to an embodiment of the present invention is a current-perpendicular-to-plane type having a structure in which a composite spacer layer including an insulating portion and a magnetic metal portion is sandwiched between a magnetization pinned layer and a magnetization free layer, wherein the magnetic film included in the magnetization pinned layer and being in contact with the composite spacer layer has a bcc structure. The magnetization pinned layer may include a stack of a plurality of magnetic films, wherein the magnetic film being in contact with the composite spacer layer has the bcc structure.

The insulating portion of the composite spacer layer includes at least one element selected from the group consisting of oxygen, nitrogen, and carbon. That is, the insulating portion of the composite spacer layer may be an oxide, a nitride, or a carbide.

The magnetic metal portion of the composite spacer layer includes at least one element selected from the group consisting of Fe, Co, and Ni, and exhibits ferromagnetism at a room temperature.

Hereinafter, embodiments of the present invention will be described with reference to the drawings.

### EXAMPLE 1

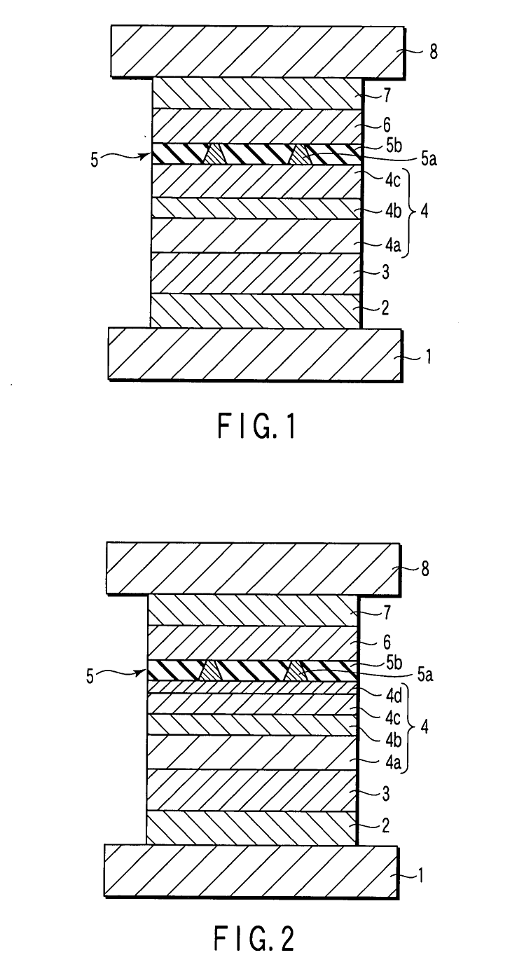

FIG. 1 is a cross-sectional view showing the magnetoresistive element in Example 1. The magnetoresistive element has a structure in which a stacked film is provided between a lower electrode (LE) 1 and an upper electrode (UE) 8. A sense current is supplied in a direction substantially perpendicular to the thickness direction of the stacked film by means of the lower electrode (LE) 1 and upper electrode (UE) 8. Thus, a CPP type GMR is realized.

In FIG. 1, the stacked film between the lower electrode (LE) 1 and the upper electrode (UE) 8 includes an underlayer 2, an antiferromagnetic layer 3, a pinned layer (magnetization pinned layer) 4, a composite spacer layer 5, a free layer (magnetization free layer) 6, and a protective layer 7. The pinned layer 4 and/or the free layer 6 may have a stacked structure.

The pinned layer 4 in FIG. 1 has a structure in which a lower pinned layer 4a and an upper pinned layer 4c are provided on the both sides of an anti-parallel coupling layer 4b in which the upper pinned layer 4c is formed of a magnetic film having a bcc structure. The composite spacer layer 5 includes magnetic metal portions 5a and an insulating portion 5b.

The magnetoresistive element of FIG. 1 is manufactured as follows. Ta [5 nm]/(Ni_{0.8}Fe_{0.2})₆₀Cr₄₀ [7 nm] as the underlayer 2, Pt₄₉Mn₅₁ [15 nm] as the antiferromagnetic layer 3, Co₉Fe₁ [3.6 nm] as the lower pinned layer 4a, Ru [0.9 nm] as the anti-parallel coupling layer 4b, and Co₅Fe₅ [2.5 nm] as the upper pinned layer 4c are successively deposited on the lower electrode 1. The upper pinned layer 4c formed of Co₅Fe₅ has a bcc structure. The composite spacer layer 5 is formed by depositing Al [1 nm], irradiating the Al layer with Ar ion beam so as to suck up the constituent element of the upper pinned layer 4c into the Al layer, and selectively oxidizing the Al layer into aluminum oxide Al—O using oxygen gas in the presence of Ar ion beam. The insulating portion 5b is primarily formed of Al—O, and the magnetic metal portion 5b is primarily formed of CoFe. Co₅Fe₅ [2.5 nm] as the free layer 6, and Cu [1 nm]/Ta [2 nm]/Ru [15 nm] as the protective layer 7 are stacked on the composite spacer layer 5. The upper electrode (UE) 8 is formed on the protective layer 7.

### COMPARATIVE EXAMPLE 1

A magnetoresistive element is manufactured in the same manner as in Example 1 except that Co₉Fe₁ [2.5 nm] is used as the upper pinned layer 4c and Co₉Fe₁ [2.5 nm] is used as the free layer 6. The upper pinned layer 4c formed of Co₉Fe₁ has an fcc structure.

### COMPARATIVE EXAMPLE 2

A magnetoresistive element is manufactured in the same manner as in Example 1 except that Co [2.5 nm] is used as the upper pinned layer 4c, Co [2.5 nm] is used as the free layer 6, and Co₉Fe₁ [2.5 nm] is used as the lower pinned layer 4a. The upper pinned layer 4c formed of Co has an fcc structure.

### EXAMPLE 2

FIG. 2 is a cross-sectional view showing the magnetoresistive element in Example 2. The magnetoresistive element has the same structure as that of FIG. 1 except that the upper pinned layer has a stacked structure of a magnetic film 4c and a magnetic film 4d. The magnetic film 4d being in contact with the composite spacer layer 5 has a bcc structure.

The magnetoresistive element of FIG. 2 is manufactured as follows. Ta [5 nm]/(Ni_{0.8}Fe_{0.2})₆₀Cr₄₀ [7 nm] as the underlayer 2, PtMn [15 nm] as the antiferromagnetic layer 3, Co₉Fe₁ [3.6 nm] as the lower pinned layer 4a, Ru [0.9 nm] as the anti-parallel coupling layer 4b, and Co₉Fe₁ [2.5 nm] and Fe [1 nm] as the magnetic films 4c and 4d of the upper pinned layer are successively deposited on the lower electrode 1. The magnetic film 4c formed of Co₉Fe₁ has an fcc structure, and the magnetic film 4d formed of Fe has a bcc structure. The composite spacer layer 5 is formed by depositing Al[1 nm], irradiating the Al layer with Ar ion beam so as to suck up the constituent element Fe of the magnetic film 4d into the Al layer, and selectively oxidizing the Al layer into Al—O using oxygen gas in the presence of Ar ion beam. The insulating portion 5b is primarily formed of Al—O, and the magnetic metal portion 5a is primarily formed of Fe. Co₉Fe₁ [2.5 nm] as the free layer 6, and Cu [1 nm]/Ta [2 nm]/Ru [15 nm] as the protective layer 7 are stacked on the composite spacer layer 5. The upper electrode (UE) 8 is formed on the protective layer 7.

COMPARATIVE EXAMPLE 3

A magnetoresistive element is manufactured in the same manner as in Example 2 except that a stack of Co₉Fe₁ [2.5 nm] and Ni [1 nm] is used as the upper pinned layer, a stack of Ni [1 nm] and Co₉Fe₁ [2.5 nm] is used as the free layer, and Co₉Fe₁ [2.5 nm] is used as the lower pinned layer 4a. The Ni layers in the upper pinned layer and in the free layer have an fcc structure.

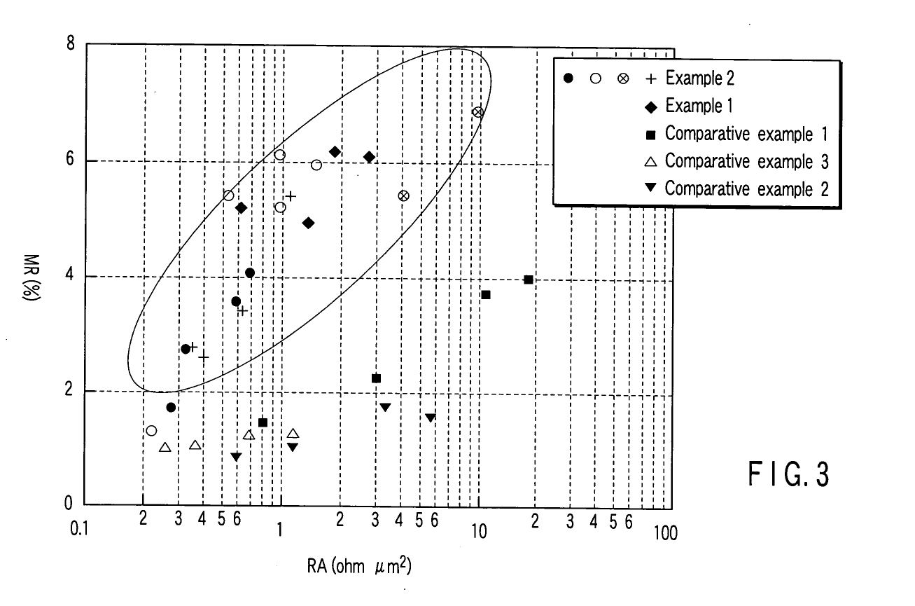

A relationship between an areal resistance RA and an MR ratio with respect to the magnetoresistive elements in Examples 1 and 2, and Comparative Examples 1, 2, and 3 is shown in FIG. 3.

As can be seen from FIG. 3, the magnetoresistive elements in Examples 1 and 2 in which the magnetic film being in contact with the composite spacer layer of the magnetic films included in the magnetization pinned layer has a bcc structure show high MR ratios (see the area surrounded by the ellipse in FIG. 3).

### EXAMPLE 3

Ta [5 nm]/Ru [2 nm] as the underlayer, Ir₂₂Mn₇₈ [7 nm] as the antiferromagnetic layer, CoFe [3 nm] as the lower pinned layer, Ru [0.9 nm] as the anti-parallel coupling layer, and CoFe [1.7 nm]/Fe [1 nm] as the upper pinned layer are successively deposited on the lower electrode. The Fe in the upper pinned layer has a bcc structure. The composite spacer layer is formed by depositing Al [1 nm], irradiating the Al layer with Ar ion beam so as to suck up the constituent element Fe of the Fe film in the upper pinned layer into the Al layer, and selectively oxidizing the Al layer into Al—O using oxygen gas in the presence of Ar ion beam. The insulating portion 5b is primarily formed of Al—O, and the magnetic metal portion 5a is primarily formed of Fe. Fe [1 nm]/NiFe [2 nm] as the free layer, and Cu [1 nm]/Ta [2 nm]/Ru [15 nm] as the protective layer are stacked on the composite spacer layer. The upper electrode is formed on the protective layer. When the MR ratio of the magnetoresistive element is measured, a high value of 200% is obtained. The RA is 1 Ωμm² or less. There is a great difference between Examples 1 and 2 and Example 3 in a period of time for which the Ar ion beam is irradiated. When the metal paths are observed with a cross-sectional TEM with respect to the elements in Examples 1 and 2, there are observed metal paths having a size in a range of 5 to 10 nm. However, it is found that most of the metal paths in the element in Example 3 have a size of 3 nm or less, which are smaller than those in Examples 1 and 2.

Not only the underlayers shown in the aforementioned examples, but also other underlayers including Ta/Cu, Ta/(Ni₁₋ₓFeₓ)_{100-y}Cr_{y} alloy (1.5<x<2.5, 20<y<45), (Ni₁₋ₓFeₓ)_{100-y}Cr_{y} alloy (1.5<x<2.5, 20<y<45), and Ta/Ni—Fe may be used. Further, as the ferromagnetic material adjacent to the composite spacer layer, Co—Fe-based alloy with another composition, Fe or Fe alloy having a bcc structure can be used.

The composite spacer layer is manufactured in such a manner that ion beam treatment is first performed and then oxidation is performed in the aforementioned examples. However, it is possible to manufacture the composite spacer layer by a method that heat treatment or plasma processing is first performed and then oxidation is performed, or a method that oxidation is first performed and then ion beam treatment, plasma treatment or heat treatment is performed. The oxidation can be performed by various methods such as natural oxidation, plasma oxidation and ion-beam oxidation.

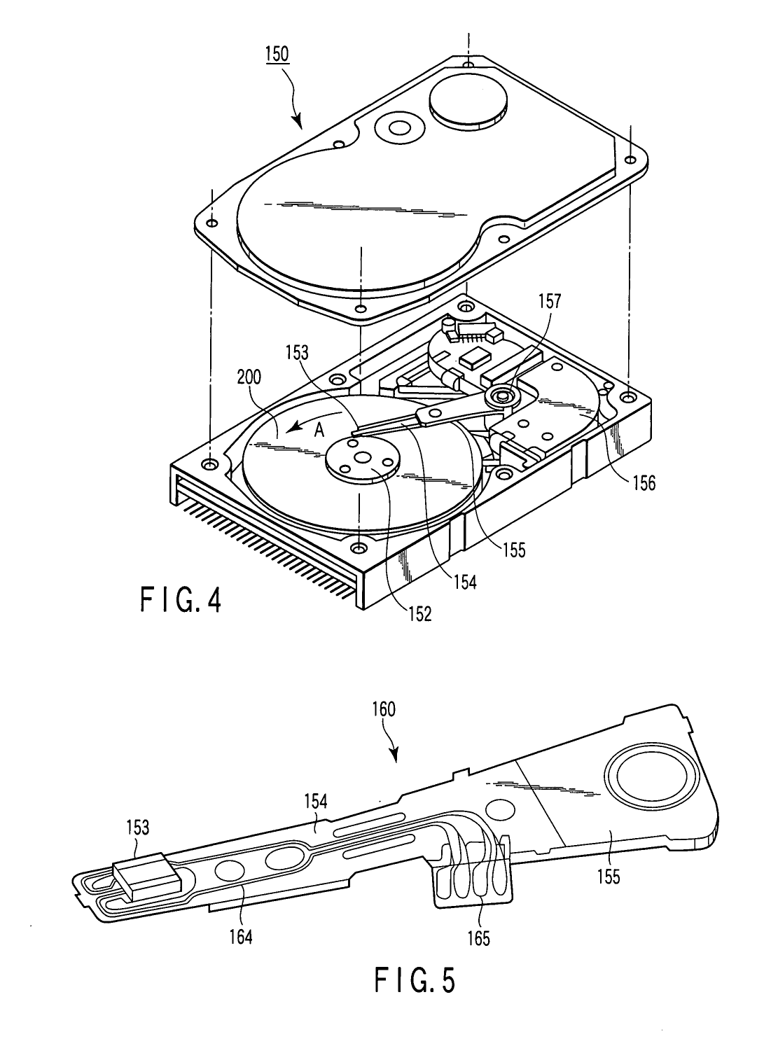

FIG. 4 is a perspective view showing a structure of a magnetic recording/reproducing apparatus. The magnetic recording/reproducing apparatus 150 uses a rotary actuator. In this drawing, a magnetic disk 200 is mounted on a spindle 152, and is rotated in the direction of the arrow A by the motor which responds to control signals from a control unit of a drive controller (not shown). The magnetic recording/reproducing apparatus 150 may comprise a plurality of magnetic disks 200.

A head slider 153 for writing data to and reading data from the magnetic disk 200 is mounted on the distal end of a suspension 154. The head slider 153 has a magnetic head comprising a magnetoresistive element according to any of the above embodiments.

When the magnetic disk 200 is rotated, the air-bearing surface (ABS) of the header slider 153 is kept at a predetermined flying height from the surface of the magnetic disk 200. Alternatively, the slider may be in contact with the medium disk 200, which is known as “in-contact type”.

The suspension 154 is connected to one end of an actuator arm 155. A voice coil motor 156, a type of a linear motor, is disposed at the other end of the actuator arm 155. The voice coil motor 156 is composed of a magnetic circuit including a driving coil (not shown) wound around a bobbin portion, and a permanent magnet and a counter yoke disposed to sandwich the coil.

The actuator arm 155 is held by ball bearings (not shown) disposed at upper and lower positions of a pivot 157, and is actuated by the voice coil motor 156.

FIG. 5 is a magnified perspective view of the distal end of the magnetic head assembly including the actuator arm 155 viewed from the disk. The magnetic head assembly 160 includes the actuator arm 155 and the suspension 154 connected to one end of the actuator arm 155.

A head slider 153 is attached to a tip of the suspension 154, and the head slider 153 comprises a magnetic head including a magnetoresistive element according to any of the above embodiments. The suspension 154 has lead wires 164 for writing and reading signals, and the lead wires 164 are connected to electrodes of the magnetic head assembled in the head slider 153. Reference numeral 165 in the figure denotes electrode pads of the magnetic head assembly 160.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A magnetoresistive element comprising:
a magnetization pinned layer including a magnetic film a magnetization direction of which is substantially pinned in one direction;
a magnetization free layer including a magnetic film a magnetization direction of which is varied depending on an external magnetic field;
a composite spacer layer interposed between the magnetization pinned layer and the magnetization free layer, and including an insulating portion and a magnetic metal portion; and
a pair of electrodes configured to supply a sense current in a direction perpendicular to planes of the magnetization pinned layer, the composite spacer layer and the magnetization free layer,
the magnetic film having a bcc structure, included in the magnetization pinned layer and being in contact with the composite spacer layer.

2. The element according to claim 1, wherein the magnetization pinned layer includes a stack of a plurality of magnetic films, and the magnetic film being in contact with the composite spacer layer has the bcc structure.

3. The element according to claim 1, wherein the magnetization pinned layer includes anti-parallel coupled two magnetic films on both sides of a Ru layer, and the magnetic film being in contact with the composite spacer layer has the bcc structure.

4. The element according to claim 1, wherein the magnetic film being in contact with the composite spacer layer is selected from the group consisting of Co—Fe-based alloy, Fe and Fe alloy has the bcc structure.

5. The element according to claim 1, wherein the magnetic film being in contact with the composite spacer layer is selected from the group consisting of Co₅Fe₅ and Fe, and has the bcc structure.

6. The element according to claim 1, wherein the insulating portion of the composite spacer layer includes at least one element selected from the group consisting of oxygen, nitrogen, and carbon.

7. The element according to claim 1, wherein the insulating portion of the composite spacer layer includes aluminum oxide.

8. The element according to claim 1, wherein the magnetic metal portion of the composite spacer layer includes at least one element selected from the group consisting of Fe, Ni, and Co.

9. The element according to claim 1, wherein the magnetic metal portion of the composite spacer layer includes a constituent element of the magnetic film being in contact with the composite spacer layer.

10. A magnetic head comprising the magnetoresistive element according to claim 1.

11. A magnetic reproducing apparatus comprising:
the magnetic head according to claim 10; and
a magnetic recording medium.
